(19) United States
(12) Patent Application Publication
(10) Pub. No.: US 2006/0083118 A1
(43) Pub. Date: Apr. 20, 2006

(54) Content recording apparatus and control method thereof

(75) Inventor: Jeong-il Choi, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/217,412

(22) Filed: Sep. 2, 2005

(30) Foreign Application Priority Data
Oct. 18, 2004 (KR) 10-2004-0083181

(51) Int. Cl. G11B 21/08

(52) U.S. Cl. 369/30.09

(57) ABSTRACT

A content recording apparatus and a control method thereof. The content recording apparatus includes a recording medium for recording more than one content and a scheduled erase time set to at least one of the recorded contents; a time information manager to provide a current time information; and a controller to check the scheduled erase time at a predetermined time intervals and to control to change a content from a reproducible state into a temporarily erased state when a scheduled erase time of the content among the at least one content having the set scheduled erase time is the same as the current time provided from the time information manager. Accordingly, it is possible to efficiently manage the limited recording area of the mass storage recording medium of the content recording apparatus.

### CROSS-REFERENCE TO RELATED APPLICATIONS

This application claims the benefit under 35 U.S.C. § 119 (a) from Korean Patent Application No. 10-2004-0083181 filed on Oct. 18, 2004 in the Korean Intellectual Property Office, the entire disclosure of which is incorporated herein by reference.

### BACKGROUND OF THE INVENTION

1. Field of the Invention

The present invention relates generally to a content recording apparatus and a control method thereof. More specifically, the present invention relates to a content recording apparatus for recording contents such as video, music, and a combination of video and music, received from an external source to a mass storage recording medium provided in the content recording apparatus, and a method for controlling the content recording apparatus.

2. Description of the Related Art

Content recording apparatuses record contents received from a content providing source to a mass storage recording medium provided in the content recording apparatus. With the development of the compression technology, a need for content recording apparatuses having mass storage recording media is increasing.

Mass storage recording media can contain various and bulk contents by use of the compression technology. The mass storage recording media include a recording area for massive content, but the recording area is subject to spatial limitation. Thus, it is required to efficiently manage the recording area. Especially, when a user sets a timer-recording function at the content recording apparatus to record a content provided from a content providing source on a mass storage recording medium at a specific time, the management of the mass storage recording medium precedes the timer-recording in order to reserve a recording area for the content to be recorded. If the volume of the content to be timer-recorded is greater than the reservable recording area, the entire content cannot be recorded. To prevent this problem, the user needs to constantly manage the mass storage recording medium such that unnecessary contents are erased in advance and the unoccupied recording area is reserved. However, such a management of the mass storage recording medium causes a cumbersome and inconvenient experience to the user.

### SUMMARY OF THE INVENTION

Additional aspects and/or advantages of the invention will be set forth in part in the description which follows and, in part, will be apparent from the description, or may be learned by practice of the invention.

The present invention has been provided to solve the above-mentioned and other problems and disadvantageous occurring in the conventional arrangement, and an aspect of the present invention provides a content recording apparatus for providing a user with wide selection with respect to a content by efficiently managing a limited recording area in a manner that a scheduled erase time is reserved for a recorded content, and a content to be erased first enters a temporarily erased state and is completely erased when a deficiency in the unoccupied recording area is determined, and a control method thereof.

To achieve the above aspect and/or features of the present invention, a content recording apparatus includes a recording medium for recording more than one content and a scheduled erase time set to at least one of the recorded contents; a time information manager for providing information relating to a current time; and a controller for monitoring the scheduled erase time at time intervals and controlling to change a certain content from a reproducible state into a temporarily erased state when a scheduled erase time of the certain content among the at least one content having the set scheduled erase time is the same as the current time provided from the time information manager.

The content recording apparatus may further include an input section for setting the scheduled erase time with respect to the at least one content recorded to the recording medium. The controller may control to store the scheduled erase time being set to the recording medium corresponding to a relevant content.

The content recording apparatus may further includes an input section for inputting a restore command with respect to a content to be restored among at least one content that is recorded to the recording medium and is changed into the temporarily erased state. The controller may control to change the content to be restored from the temporarily erased state into the reproducible state when the restore command is input.

The controller may control to select and erase at least one content among the at least one content changed into the temporarily erased state on a specific basis upon determining to erase the at least one content changed into the temporarily erased state.

The determination to erase the at least one content changed into the temporarily erased state may be based on a detection of a deficient recording area of the recording medium when a new content is recorded to the recording medium.

The specific basis is to select a content having the earliest scheduled erase time among the at least one content changed into the temporarily erased state.

According to another aspect of the present invention, a control method of a content recording apparatus having a recording medium that stores more than one content, includes recording a scheduled erase time to the recording medium when the scheduled erase time is set to at least one content among the more than one content being recorded; monitoring the scheduled erase time at time intervals; and changing a certain content from a reproducible state into a temporarily erased state when a scheduled erase time of the certain content among the at least one content having the set scheduled erase time is the same as a current time according to the monitoring.

The control method may further include changing a content to be restored from the temporarily erased state into the reproducible state when a restore command is input with respect to the content to be restored among at least one content that is recorded to the recording medium and is changed into the temporarily erased state.

The control method may further comprise the step of controlling to select and erase at least one content among the at least one content changed into the temporarily erased state on a specific basis upon determining to erase the at least one content changed into the temporarily erased state.

Accordingly, it is possible to efficiently manage the limited recording area of the mass storage recording medium of the content recording apparatus.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of exemplary embodiments, taken in conjunction with the accompanying drawing figures of which:

FIG. 1 is a diagram of a display system employing a content recording and reproducing apparatus according to an embodiment of the present invention;

FIG. 2 is a block diagram of the content recording and reproducing apparatus of FIG. 1;

FIG. 3 is an on-screen display (OSD) screen displayed to a user through an external output device to show lists of contents recorded on a mass storage recording medium with a scheduled erase time set; and

FIG. 4 is a flowchart explaining a method for controlling the content recording and reproducing apparatus.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, the present invention is illustrated by employing a content recording and reproducing apparatus to realize the present invention. It is understood that a content recording apparatus can be utilized, without deviating from the inventive scope of the present invention.

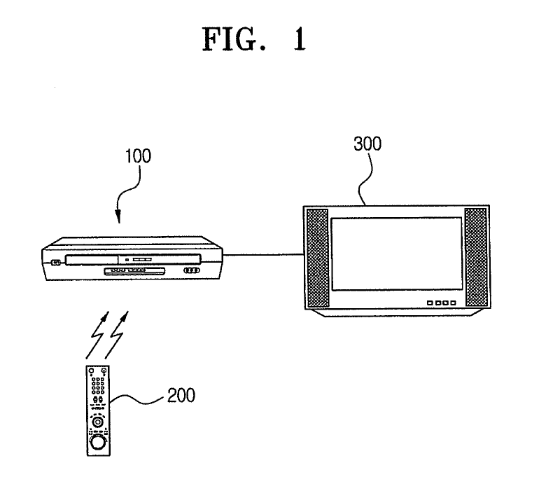

FIG. 1 depicts a display system employing a content recording and reproducing apparatus according to an embodiment of the present invention.

Referring to FIG. 1, the content recording and reproducing apparatus 100 is connected to an external output device 300 through a transmission cable. In an embodiment of the present invention, the external output device 300 is a television.

The content recording and reproducing apparatus 100 processes a signal from an external input device, and transfers display information to the external output device 300. Note that the external input device may be a remote controller 200 emitting a radio signal such as infrared rays, or various input devices such wired keyboards. In an embodiment of the present invention, the external input device is a remote controller 200.

Hereinafter, it is illustrated that a user command is input through the remote controller 200. Note that the user command may be input through, for example, an operation panel (not shown) provided to the content recording and reproducing apparatus 100.

The content recording and reproducing apparatus 100 is realized to receive more than one content from diverse content providing sources. Examples of the content providing source may be various media capable of transferring a signal, such as a terrestrial television broadcasting, a satellite broadcasting, a lead-in cable, a computer line, and a modem line. In the present invention, the content recording and reproducing apparatus 100 can receive contents from at least one of content providing sources including a cable, a satellite dish antenna, a local cable, a digital broadcast source (DBS), a conventional antenna, Internet, a computer source, a camcorder, a disk player, and a set-top box.

The content recording and reproducing apparatus 100 includes a mass storage recording medium to record more than one content. The mass storage recording medium may be a hard disk drive.

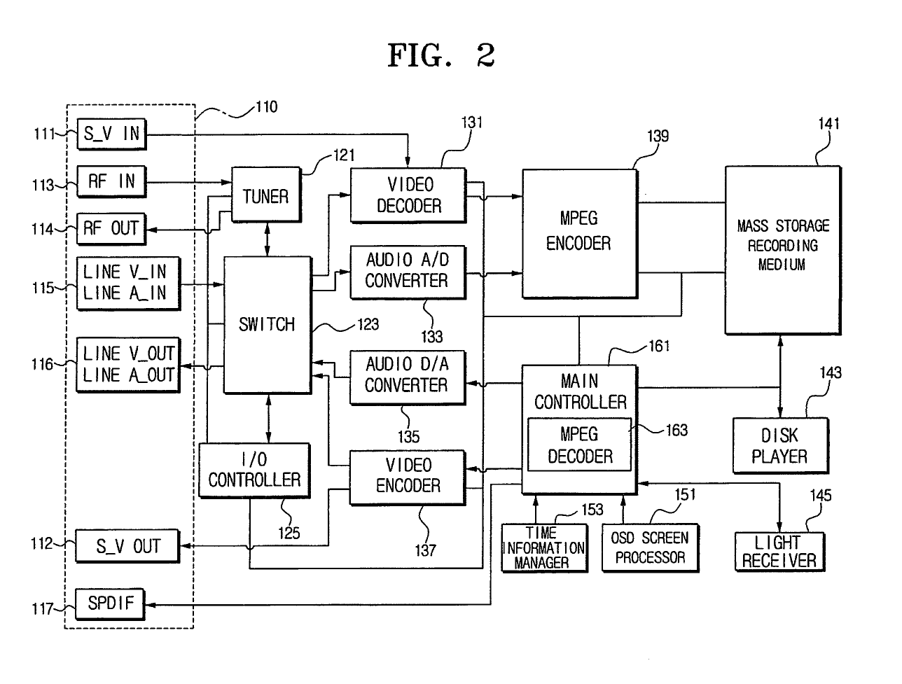

FIG. 2 is a block diagram of the content recording and reproducing apparatus 100.

Referring to FIG. 1 and FIG. 2, the content recording and reproducing apparatus 100 includes an input and output (I/O) interface 110, a tuner 121, a switch 123, an I/O controller 125, a video decoder 131, an audio analog-to-digital (A/D) converter 133, an audio digital-to-analog (D/A) converter 135, a video encoder 137, an moving picture experts group (MPEG) encoder 139, a mass storage recording medium 141, a disk player 143, a light receiver 145, an on-screen display (OSD) screen processor 151, a time information manager 153, and a main controller 161.

Various contents are input from a content providing source to the content recording and reproducing apparatus 100 via the I/O interface 110. A signal-processed content at the content recording and reproducing apparatus 100 is output to the external output device 300. The I/O interface 110 includes a super video input terminal (S_V IN) 111, a super video output terminal (S_V OUT) 112, a RF input terminal (RF IN) 113, a RF output terminal (RF OUT) 114, a line video and audio input terminal (LINE V_IN, LINE A_IN) 115, a line video and audio output terminal (LINE V_OUT, LINE A_OUT) 116, and a digital audio signal output terminal that is a serial parallel digital interface (SPDIF) 117.

The super video input terminal (S_V IN) 111 and output terminal (S_V OUT) 112 receive a luminance signal Y and color difference signals Cr and Cb that are separate digital signals, from a digital camcorder, a DVD player, a set-top box, and the like. The received super video signals go through a certain signal processing and are output to the external output device 300.

The RF input terminal (RF IN) 113 and output terminal (RF OUT) 114, which are generally connected to an antenna, receive a terrestrial broadcast signal. The received terrestrial broadcast signal is output to the external output device 300.

The line video and audio input terminal (LINE V_IN, LINE A_IN) 115 and output terminal (LINE V_OUT, LINE A_OUT) 116 receive an analog content signal being the combination of the luminance signal Y and the chrominance signal C, from a camcorder, a DVD player, a set-top box, and the like supporting the output of the analog content. The received analog content signal goes through a certain signal processing at the content recording and reproducing apparatus 100 and is output to the external output device 300.

The digital audio signal output terminal (SPDIF) 117 outputs a digital audio signal from the main controller 161 to an external device (not shown).

The tuner 121 adjusts a receive channel so that the RF input terminal (RF IN) 113 can receive a broadcast signal over a channel requested from the I/O controller 125 being under the control of the main controller 161. The switch 123 selectively switches the signals input to and output from the I/O interface 110 under the control of the I/O controller 125.

The I/O controller 125 controls the signals input to and output from the I/O interface 110 under the control of the main controller 161.

The video decoder 131 decodes and outputs a video signal from the super video input terminal (S_V IN) 111 or the switch 123 under the control of the main controller 161.

The audio A/D converter 133 converts the analog audio signal input via the switch 123 to a digital signal, and outputs the digital signal to the MPEG encoder 139. The audio D/A converter 135 converts a digital audio signal output from an MPEG decoder 163 of the main controller 161 to an analog audio signal, and outputs the analog audio signal to the switch 123.

The video encoder 137 encodes the video signal from the video decoder 131 or the MPEG decoder 163, and outputs the encoded video signal to the switch 123.

The MPEG encoder 139 encodes the audio signal from the audio A/D converter 133 and the video signal from the video decoder 131 into a certain compression format under the control of the main controller 161. The present invention adopts the MPEG compression standard, but not limited to this compression format.

Various contents, such as video, audio, and the combination of video and audio, input from the I/O interface 110 are recorded to the mass storage recording medium 141. The mass storage recording medium 141 also stores a scheduled erase time set by the user as well as title information, volume information, modification date information in relation with the individual content.

In addition, the mass storage recording medium 141 stores contents in a reproducible state and a temporarily erased state (or flagged for erasive state).

For example, given that content is recorded to the mass storage recording medium 141 as the reproducible state, the content can be output to the external output device 300 according to a reproducing command of the remote controller 200. If the content recorded to the mass storage recording medium 141 is in the temporarily erased state, the certain content is not reproduced even when the reproducing command is input from the remote controller 200. However, if the user inputs a restore command for the content, the content is changed from the temporarily erased state in to the reproducible state to be reproduced.

The disk player 143 is built in the content recording and reproducing apparatus 100, and records and reproduces contents under the control of the main controller 161. The disk player 143 may be a digital versatile disk (DVD) player to reproduce data from DVDs and/or compact disks (CDs).

The light receiver 145 receives the user command emitted from the remote controller 200 being the external input device, and provides the received user command to the main controller 161. User commands are input through the remote controller 200, and user signals from the remote controller 200 are input to the light receiver 145 in correspondence with the relevant user commands.

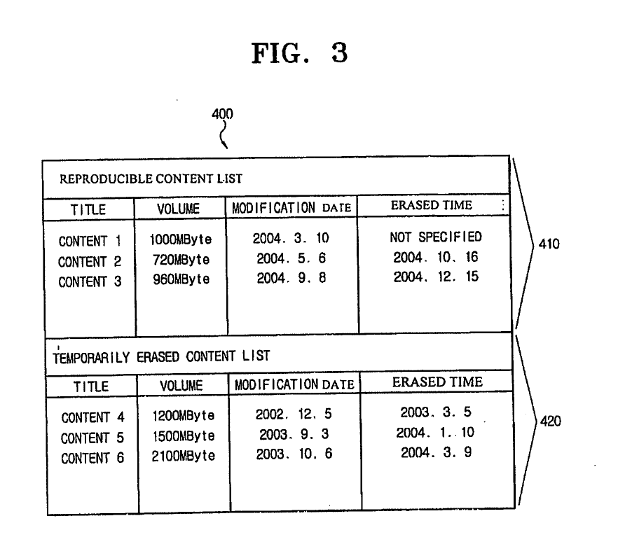

The OSD (on screen display) screen processor 151 provides an OSD screen relating to functions of the content recording and reproducing apparatus 100 under the control of the main controller 161. The OSD screen processor 151 creates an OSD screen requested by the user through the remote controller 200, and the created OSD screen is displayed at the external output device 300. According to an aspect of the present invention, when the user inputs a list display command of the contents recorded on the mass storage recording medium 141 through the remote controller 200, the OSD screen processor 151 processes to create and transfer the OSD screen, as shown in FIG. 3, to the external output device 300. The OSD screen in FIG. 3 is created based on information relating to the content retrieved from the mass storage recording medium 141 by the main controller 161, such as title information, volume information, modification date information, and a scheduled erase time of the respective contents.

The time information manager 153 manages time information applied to the content recording and reproducing apparatus 100. Specifically, the time information manager 153 provides a set current time to the content recording and reproducing apparatus 100. In addition, the time information manager 153 manages time information relating to a timer-recording function of the content recording and reproducing apparatus 100.

The main controller 161 processes the user command received through the light receiver 145, and controls the components of the content recording and reproducing apparatus 100. The main controller 161 includes the MPEG decoder 163 that decodes the content compressed according to the MPEG compression standard. It is illustrated that the main controller 161 is realized as a single chip including the MPEG decoder 163 therein, by way of example. It is to be understood that the MPEG decoder 163 can be realized as a separate chip.

The main controller 161 manages the reproducing and recording of the content recorded on the mass storage recording medium 141 and/or the disk player 143. More specifically, the main controller 161 controls to record the content written in the disk player 143 or the content encoded at the MPEG encoder 139 to the mass storage recording meidum 141.

The main controller 161 checks a scheduled erase time of the respective contents recorded on the mass storage recording medium 141 at predetermined time intervals, and determines whether one of the scheduled erase times is the same as the current time provided from the time information manager 153. If the one of the scheduled erase times is the same as the current time, the main controller 161 controls to change the related content from the reproducible state into the temporarily erased state.

In the event that it is determined that a recording area of the mass storage recording medium 141 is deficient, for example, if the timer-recording function is set and the deficiency of the recording area is determined during the timer-recording of the content, the main controller 161 controls to completely erase at least one of the contents in a temporarily erased state list from the mass storage recording medium 141.

The following describes how to completely erase the content in the temporarily erased state list upon the setting of the timer-recording function.

If the timer-recording function is set and a relevant content stream is input from the content providing source at a specified time, the main controller 161 controls to compress and store the received content stream to the mass storage recording medium 141. Note that the main controller 161 records the received content stream to the mass storage recording medium 141 while determining the sufficiency or the deficiency of the unoccupied recording area of the mass storage recording medium 141. When the unoccupied recording area is enough, the main controller 161 controls to continue to compress the content stream input according to the set timer-recording function and to record the compressed content to the mass storage recording medium 141.

Otherwise, when the unoccupied recording area is deficient, the main controller 161 retrieves a content having the earliest scheduled erase time from the contents being in the temporarily erased state, and controls to completely erase the retrieved content from the mass storage recording medium 141.

It is illustrated that the content having the earliest scheduled erase time is first erased from the mass storage recording medium 141, but not limited to this content. It is possible to set to first erase a content having the greatest volume among the contents is the temporarily erased state list or use some other priority erase scheme.

In addition, it is illustrated that the content in the temporarily erased state is completely erased from the mass storage recording medium 141 because the unoccupied recording area is deficient according to the setting of the timer-recording function, but not limited to this cause.

FIG. 3 shows the OSD screen displayed to the user though the external output device 300, in which each list organizes the contents recorded to the mass storage recording medium 141 with the scheduled erase time specified.

In FIG. 3, a content list screen 400 displayed as the OSD screen includes a reproducible content list 410 and a temporarily erased content list 420. The reproducible content list 410 and the temporarily erased content list 420 respectively include a title, a volume, a modification date, and a scheduled erase time (or erased time). In FIG. 3, the current time is Oct. 13, 2004.

The reproducible content list 410 enumerates contents being in the reproducible state, for example, a first content, a second content, and a third content. The first content does not have a specified scheduled erase time, and the second and third contents have the specified scheduled erase time. The user specifies the scheduled erase time by selecting an intended content on the content list screen 400 by using the remote controller 200. The specified scheduled erase time is recorded in a predetermined recording area of the mass storage recording medium 141 in correspondence with the relevant content under the control of the main controller 161. The scheduled erase time may be set separately from the content list, or may be set together when the content is recorded to the mass storage recording medium 141.

The temporarily erased content list 420 enumerates contents being in the temporarily erased state, for example, a fourth content, a fifth content, and a sixth content. The fourth content has the earliest erased time among the contents. Accordingly, when the user intends to set the timer-recording function, the main controller 161 controls to record the first content through the sixth content in advance and to completely erase the fourth content having the earliest erased time from the mass storage recording medium 141 upon determining the deficiency of the recording area at the mass storage recording medium 141. When the volume of the content to be timer-recorded is greater than the recording area obtained by erasing the fourth content, the main controller 161 controls to completely erase the fifth content having the next earliest erased time to additionally obtain the unoccupied recording area at the mass storage recording medium 141.

It is to be understood that the reproducible content list 410 and the temporarily erased content list 420 respectively can be provided to the user through separate OSD screens.

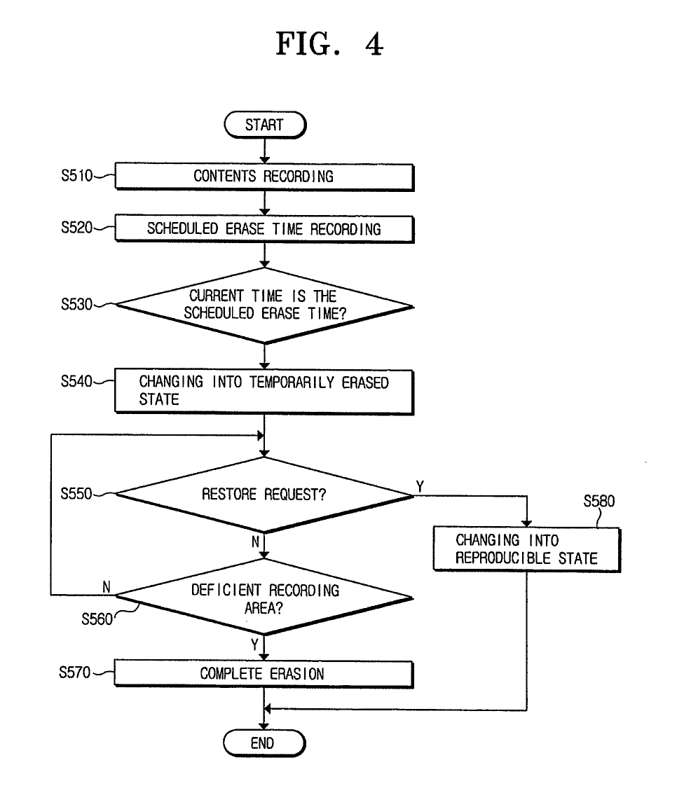

FIG. 4 is a flowchart explaining how the content recording and reproducing apparatus is controlled according to an embodiment of the present invention.

Referring to FIG. 1 through FIG. 4, the user selects a desired content to be recorded among the various contents provided from the content providing source, and inputs the recording command through the remote controller 200. The selected content is recorded to the mass storage recording medium 141 of the content recording and reproducing apparatus 100. In the same manner, more than one content is recorded to the mass storage recording medium 141 (S510).

Simultaneously, when the user inputs the scheduled erase time for the respective contents through the remote controller 200, the scheduled erase time is recorded to a predetermined area of the mass storage recording medium 141 corresponding to the respective contents (S520).

The main controller 161 checks at predetermined time intervals the scheduled erase time of the each content recorded to the mass storage recording medium 141. The main controller 161 determines whether the current time provided from the time information manager 153 is the same as the scheduled erase time of a content (S530). According to an embodiment of the present invention, the content has the earliest scheduled erase time based on the current time.

When the current time is the same as or after (i.e., matches) the scheduled erase time of the certain content, the main controller 161 changes the content from the reproducible state into the temporarily erased state (S540). After repeating operations S520, S530, and S540, at least one content is stored as the temporarily erased state on the mass storage recording medium 141.

If the user inputs the restore command for a content to be restored among the temporarily erased contents through the remote controller 200 (S550), the main controller 161 controls to change the content to be restored from the temporarily erased state into the reproducible state (S580). As a result, the user can reproduce the restored content being in the reproducible state.

While the user does not input the restore command with respect to the content entering the temporarily erased state (S550), upon determining the deficiency of the recording area at the mass storage recording medium 141, the main controller 161 selects a content among the contents in the temporarily erased state list and controls to completely erase the selected content from the mass storage recording medium 141 (S570) based on predetermined criterion. According to an embodiment of the present invention, the predetermined criteria is to select a content having the earliest scheduled erase time among the contents in the temporarily erased state list. It is also understood that a next predetermined criteria is if the erasion of one content is not enough to obtain the required recording area.

Therefore, the user can erase unnecessary contents automatically without having to manually manage the mass storage recording medium 141, and thus the recording area of the mass storage recording medium 141 can be efficiently utilized.

According to an embodiment of the present invention, the scheduled erase time of the respective contents is set through the content list screen 400, but not limited to this manner. It is to be understood that the scheduled erase time may be set through a separate OSD screen or the remote controller 200 without the OSD screen.

As explained above, the content recording apparatus and the control method enable to efficiently manage the limited recording area of the mass storage recording medium and to provide the user with the wide selection for the erasion of the unnecessary contents. Furthermore, it is possible to prevent the timer-recording failure due to the deficient recording area.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A content recording apparatus, comprising:
a recording medium to record more than one content and a scheduled erase time set to at least one of the recorded contents;
a time information manager to provide a current time information; and
a controller to check the scheduled erase time at a predetermined time intervals and control to change a content from a reproducible state into a temporarily erased state when a scheduled erase time of the content among the at least one content having the set scheduled erase time matches the current time provided from the time information manager.

2. The content recording apparatus according to claim 1, further comprising an input part to set the scheduled erase time with respect to the at least one content recorded on the recording medium,
wherein the controller controls to store the scheduled erase time being set to the recording medium corresponding to a relevant content.

3. The content recording apparatus according to claim 1, further comprising an input part to input a restore command with respect to a content to be restored among at least one content that is recorded on the recording medium a temporarily erased state,
wherein the controller controls to change the content to be restored from the temporarily erased state into the reproducible state when the restore command is input.

4. The content recording apparatus according to claim 1, wherein the controller controls to select and erase at least one content among the at least one content in a temporarily erased state list by a predetermined criteria.

5. The content recording apparatus according to claim 4, wherein the predetermined criteria to erase the at least one content in the temporarily erased state is based on a detection of a deficient recording area of the recording medium when a new content is recorded on the recording medium.

6. The content recording apparatus according to claim 4, wherein the predetermined criteria is to select a content having the earliest scheduled erase time among the at least one content in the temporarily erased state list.

7. A control method of a content recording apparatus having a recording medium that stores more than one content, the control method comprising:
recording a scheduled erase time to the recording medium when the scheduled erase time is set to at least one content among the more than one content being recorded;
checking the scheduled erase time at a predetermined time intervals; and
changing a content from a reproducible state into a temporarily erased state when a scheduled erase time of the certain content among the at least one content having the set scheduled erase time matches a current time according to the checking.

8. The control method according to claim 7, further comprising changing a content to be restored from the temporarily erased state into the reproducible state when a restore command is input with respect to the content to be restored among at least one content that is recorded to the recording medium in a temporarily erased state list.

9. The control method according to claim 7, further comprising controlling to select and erase at least one content among the at least one content in the temporarily erased state list by a predetermined criteria.

10. The control method according to claim 9, wherein the predetermined criteria to erase the at least one content in a temporarily erased state list is based on a detection of a deficient recording area of the recording medium when a new content is recorded to the recording medium.

11. The control method according to claim 9, wherein the predetermined criteria is to select a content having the earliest erased time among the at least one content in a temporarily erased state list.

12. The control method according to claim 9, further comprising displaying a reproducible content list and temporarily erased content list simultaneously.

13. A method for controlling a stored content; comprising;
determining whether enough space is available in a mass storage recorder to store a content in association with storing the content; and
erasing a content flagged for erasure when enough space is not available.
